(19) United States
(12) Patent Application Publication
(10) Pub. No.: US 2013/0202127 A1
(43) Pub. Date: Aug. 8, 2013

(54) Condenser-Type Sounding Body Unit and Earphone Employing Same

(71) Applicants: Takashi MIYAKURA, Osaka (JP); Hiroki Niho, Osaka (JP)

(72) Inventors: Takashi MIYAKURA, Osaka (JP); Hiroki Niho, Osaka (JP)

(73) Assignee: HOSIDEN CORPORATION, Osaka (JP)

(21) Appl. No.: 13/561,402

(22) Filed: Jul. 30, 2012

(30) Foreign Application Priority Data
Aug. 2, 2011 (JP) 2011-169461

(51) Int. Cl. H04R 1/10

(52) U.S. Cl. CPC H04R 1/1058
USPC 381/74

(57) ABSTRACT

A condenser-type sounding body unit is provided with a casing; a plate electrode comprising a conductor; a diaphragm disposed in opposition to the plate electrode; a spacer for insulating the plate electrode and the diaphragm, the spacer being disposed between the plate electrode and the diaphragm; a pair of signal input terminals electrically connected to the plate electrode and the diaphragm respectively; and a sandwiching section. The sandwiching section has a first sandwiching section comprising an insulating material and a second sandwiching section comprising a conductive material. The sandwiching section sandwiches the plate electrode and the diaphragm from both sides in the direction of opposition thereof. The diaphragm, in a state of being affixed to the second sandwiching section, is housed within the casing. A sound hole is formed in the casing, in a position in opposition to the diaphragm.

### BACKGROUND OF THE INVENTION

1. Field of the Invention

The present invention relates to a condenser-type sounding body unit provided with a diaphragm and plate electrodes, and to an earphone employing the condenser-type sounding body unit.

2. Description of the Related Art

A condenser-type sounding body is one type of sounding body that has been utilized in the past. Techniques relating to such a condenser-type sounding body have been disclosed in Japanese Laid-Open Patent Application 2009-117888 and Japanese Laid-Open Patent Application 4-276999.

An electrostatic speaker disclosed in Japanese Laid-Open Patent Application 2009-117888 comprises being provided with a first electrode, a second electrode, and a diaphragm. The diaphragm is furnished between the first electrode and the second electrode, but is spaced apart from the individual electrodes. On the first electrode and the second electrode, an electret layer is formed on the surface thereof that faces towards the diaphragm.

In the condenser speaker disclosed in Japanese Laid-Open Patent Application 4-276999, a diaphragm and a fixed pole are disposed facing one another, and a polarization voltage is applied to effect driving. A plurality of electrodes are furnished to the diaphragm, and it is possible for polarization voltage to be applied to each electrode.

In the technique disclosed in Japanese Laid-Open Patent Application 2009-117888, for output of sound, the first electrode and the second electrode are individually supplied with a signal of the opposite phase of the signal supplied to the diaphragm. Consequently, in order for the sound to be propagated from the diaphragm to an electrostatic type speaker, it is necessary to furnish the first electrode, the second electrode, or both, with a hole. The formation of this hole requires a separate step, and therefore the production cost is higher. Moreover, it is necessary to input a signal individually to the diaphragm, the first electrode, and the second electrode, and therefore the structure is rather complex and not easily reduced in size.

On the other hand, a two-layer structure of a diaphragm and a fixed pole can be adopted as in the technique disclosed in Japanese Laid-Open Patent Application 4-276999, but a switching circuit will be needed to individually apply the plurality of polarization voltages to the corresponding plurality of electrodes. Therefore, the structure is rather complex, production cost is higher, and size reduction is not easy.

With the foregoing in view, it is an object of the present invention to offer a condenser-type sounding body unit of compact size, achievable at low cost. A further object is to offer an earphone employing such a condenser-type sounding body unit.

### SUMMARY OF THE INVENTION

In order to attain the aforementioned object, a condenser-type sounding body unit according to an aspect of the present invention is provided with a casing; a plate electrode comprising a conductor; a diaphragm disposed in opposition to the plate electrode; a spacer for insulating the plate electrode and the diaphragm, the spacer disposed between the plate electrode and the diaphragm; a pair of signal input terminals electrically connected to the plate electrode and the diaphragm respectively; and a sandwiching section, wherein the sandwiching section has a first sandwiching section comprising an insulating material and a second sandwiching section comprising a conductive material; the sandwiching section sandwiches the plate electrode and the diaphragm from both sides in the direction of opposition thereof; the diaphragm, in a state of being affixed to the second sandwiching section, is housed within the casing; and a sound hole is formed in the casing, in a position in opposition to the diaphragm.

According to the aspect described above, a condenser can be configured of one plate electrode and one diaphragm. Therefore, as compared with a conventional structure in which the condenser comprises two plate electrodes and one diaphragm, a more compact configuration is possible. Moreover, only electrical continuity control of the one plate electrode and the one diaphragm is necessary, and therefore electrical continuity control can be performed easily. Additionally, because the sound hole is formed at a position in opposition to the diaphragm, it is possible for sound generated by vibration of the diaphragm to be easily extracted through the sound hole. Moreover, the signal input terminals can be configured from two terminals connected to the plate electrode and the diaphragm respectively. Consequently, it is possible to reduce the production costs. Further, by furnishing a spacer between the plate electrode and the diaphragm, a fixed gap can be maintained between the plate electrode and the diaphragm, making it possible to obtain stabilized sensitivity. Moreover, by virtue of a structure in which the components mentioned above are housed in a casing, it is possible to achieve a compact size overall.

In preferred practice, the plate electrode and the signal input terminal for connection to the plate electrode are connected via wiring furnished to the plate electrode, in a central portion of an area thereof surrounded by the sandwiching section.

This configuration affords a structure whereby a fixed gap is maintained between the plate electrode and the diaphragm by the sandwiching section, while a central portion of the plate electrode is also supported by the wiring. Therefore, it is possible for a fixed gap to be maintained between the plate electrode and the diaphragm, in the central portion. Consequently, the effect of preventing displacement of position of the plate electrode can be enhanced further, and it is therefore possible to enhance the stability of sensitivity.

In preferred practice, the plate electrode and the signal input terminal for connection to the plate electrode are connected via a tubular member furnished along the inside peripheral face of either the first sandwiching section or the second sandwiching section.

With this configuration, it is possible to readily connect the diaphragm and the signal input terminals used for connection to the diaphragm. Consequently, it is possible to reduce the production cost. Moreover, because the plate electrode can be supported by the tubular member, displacement of the position of the plate electrode can be prevented, and it is therefore possible to enhance the stability of sensitivity.

In preferred practice, the diaphragm and the signal input terminal for connection to the diaphragm are connected at least via the casing.

According to this aspect, it is possible to readily establishing a connection between the diaphragm and the signal input terminals for connecting to the diaphragm. Consequently, the cost of materials can be reduced, making it possible to keep production costs low.

An earphone according to another aspect of the present invention is provided with the aforementioned condenser-type sounding body unit; and a case member for housing the condenser-type sounding body unit; wherein the case member has a sound output section disposed in opposition to the sound hole.

According to the aspect described above, it is possible to configure a compact earphone having good characteristics.

In preferred practice, the earphone is provided with a voltage conversion section for boosting a sound signal input to the condenser-type sounding body unit, the voltage conversion section being housed in the case member.

According to this aspect, the earphone can be configured in a compact size.

### BRIEF DESCRIPTION OF THE DRAWINGS

FIG. 1 is a side sectional view of a condenser-type sounding body unit according to a first embodiment;

FIG. 2 is a development view of the condenser-type sounding body unit according to the first embodiment;

FIG. 3 is a side sectional view of a condenser-type sounding body unit according to a second embodiment;

FIG. 4 is a development view of the condenser-type sounding body unit according to the second embodiment; and

FIG. 5 is a side sectional view of an earphone.

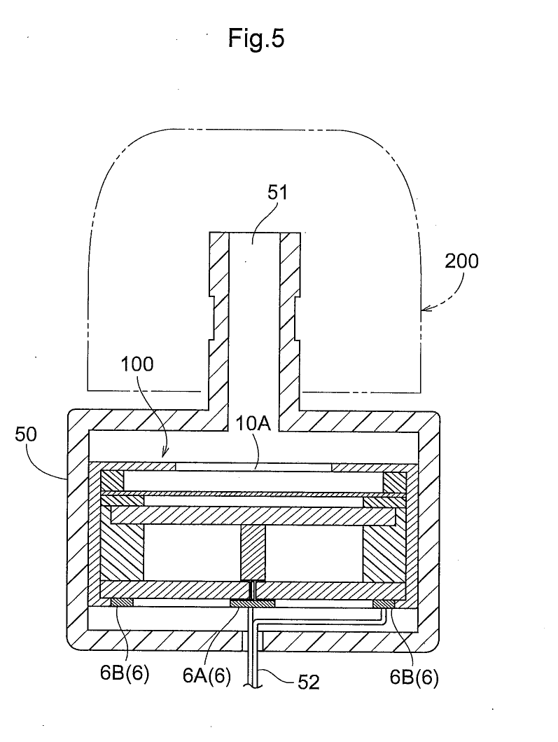

### DESCRIPTION OF THE PREFERRED EMBODIMENTS

### First Embodiment

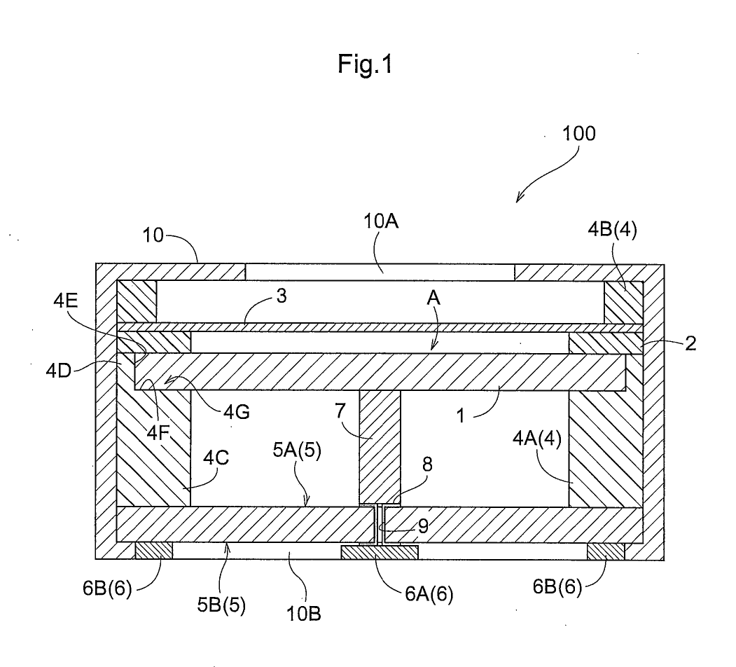

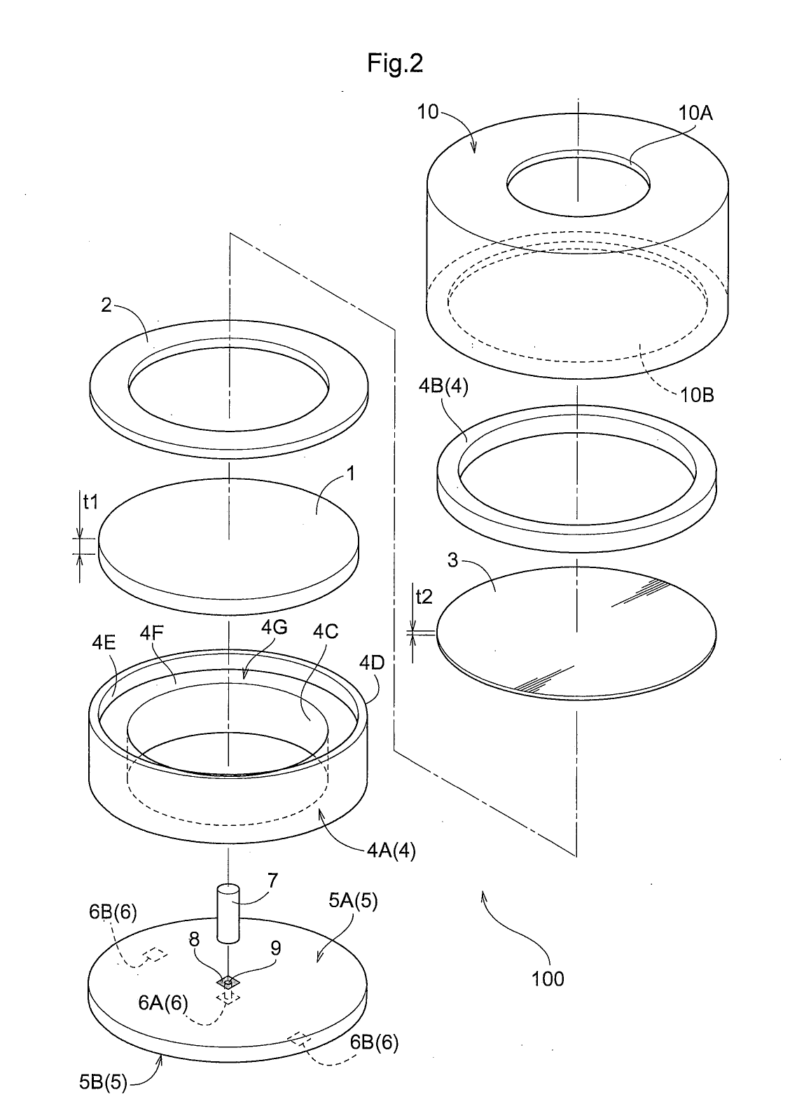

The embodiments of the present invention are described in detail below. A condenser-type sounding body unit (hereinafter referred to as a “sounding body”) 100 according to the present invention is provided with a function of outputting an electrical signal as sound. The sounding body 100 is shown in a side sectional view in FIG. 1, while the sounding body 100 is shown in a development view in FIG. 2. Hereinbelow, FIG. 1 and FIG. 2 will be employed to describe the configuration of the sounding body 100. As shown in FIG. 1 and FIG. 2, the sounding body 100 is provided with a plate electrode 1, a spacer 2, a diaphragm 3, a sandwiching section 4, a substrate 5, and a casing 10.

The plate electrode 1 comprises a conductor of plate form. The plate electrode 1 according to the present embodiment is a formed to disk shape of thickness t1.

The spacer 2 comprises an insulating material of cylindrical shape. The inside diameter of the spacer 2 is formed to be smaller than the outside diameter of the plate electrode 1, and the outside diameter of the spacer 2 to be larger than the outside diameter of the plate electrode 1. Consequently, the configuration is such that the plate electrode 1 will not pass through the hole in the diametrical center section of the spacer 2. In preferred practice, the thickness of the spacer 2 configured in this manner is about 0.2 mm, for example.

The diaphragm 3 is disposed in opposition to the plate electrode 1, with the spacer 2 therebetween. In so doing, the diaphragm 3 is insulated from the plate electrode 1. As mentioned previously, the spacer 2 comprises an insulating material of cylindrical shape. The plate electrode 1 and the diaphragm 3 are disposed in opposition, with the spacer 2 sandwiched therebetween. The diaphragm 3 comprises a conductive film having an outside diameter comparable to that of the spacer 2, and sufficiently thinner than the thickness t11 of the plate electrode 1 (thickness t2: several microns). As shown in FIG. 1, a space A is formed between the plate electrode 1 and the diaphragm 3.

The sandwiching section 4 is configured to have a first sandwiching section comprising an insulating material, and a second sandwiching section comprising a conductive material. In the present embodiment, the first sandwiching section comprises a holder 4A, and the second sandwiching section comprises a diaphragm ring 4B. Consequently, the holder 4A comprises an insulating material, and the diaphragm ring 4B comprises a conductive material. Additionally, the diaphragm 3 is secured by bonding to the diaphragm ring 4B. In this state, the sandwiching section 4 sandwiches the plate electrode 1 and the diaphragm 3 from both sides in the opposition direction. The opposition direction refers to the direction of opposition of the plate electrode 1 and the diaphragm 3, specifically, to the axial direction of the plate electrode 1 and the diaphragm 3.

In the present embodiment, the holder 4A has a small-diameter section 4C having the same inside diameter as the inside diameter of the spacer 2, and a large-diameter section 4D having an inside diameter larger than the inside diameter of the small-diameter section 4C. The plate electrode 1 is arranged transversely and mates with a recessed section 4G formed by an inside peripheral wall face 4E of the large-diameter section 4D and an axial end face 4F of the small-diameter section 4C. Consequently, the axial length of the large-diameter section 4D is set such that, in a state in which the plate electrode 1 is mated with the recessed section 4G, the plate electrode 1 does not protrude past the axial end section of the large-diameter section 4D. Moreover, because the inside peripheral wall face 4E of the large-diameter section 4D is positioned to the outside in the diametrical direction from the plate electrode 1, displacement in position of the plate electrode 1 in the diametrical direction can be prevented.

The diaphragm ring 4B comprises a conductive material of cylindrical shape. The outside diameter of the diaphragm ring 4B is comparable to the outside diameter of the diaphragm 3, while the inside diameter of the diaphragm ring 4B is formed to larger size than the inside diameter of the spacer 2. Also, the diaphragm ring 4B is configured to have greater thickness than the spacer 2. In so doing, even in a case in which the diaphragm 3 vibrates at an amplitude corresponding to the axial length of the space A, the vibrating diaphragm 3 will not contact the casing 10, as will be discussed below. Consequently, vibration commensurate with the axial length of the space A can be permitted.

The holder 4A is furnished to the outside in the opposition direction from the plate electrode 1, while the diaphragm ring 4B is furnished to the outside in the opposition direction from the diaphragm 3. In so doing, the plate electrode 1 and the diaphragm 3, in a state with the spacer 2 interposed therebetween, are sandwiched between the holder 4A and the diaphragm ring 4B.

The substrate 5 comprises a printed substrate of disk shape. The substrate 5 is configured to have an outside diameter comparable to the outside diameter of the holder 4A, and is disposed in opposition to the plate electrode 1, with the holder 4A interposed therebetween. A land 8 to which is connected a metal wire 7 that is electrically connected to the plate electrode 1 is formed on a first surface 5A of the substrate 5. A via 9 that is electrically connected to the land 8 and that passes through to a second surface 5B side of the substrate 5 is formed in the substrate 5. A conductive film is formed at least on the inside peripheral surface of the via 9.

Here, the plate electrode 1 and a signal input terminal 6A for connection to the plate electrode 1 are connected via wiring that is furnished in a central portion of an area in the plate electrode 1 surrounded by the holder 4A. In the present embodiment, the holder 4A comprises a cylindrical shape. Because of this, the plate electrode 1 and the holder 4A abut along a circular surface. Consequently, the central portion of the area surrounded by the holder 4A corresponds to the central area of the circular shape (specifically, an area to the inside in the diametrical direction). The wiring may be disposed at any position in this central area. The wiring corresponds to the metal wire 7 mentioned previously. In a case in which the outside peripheral portion of the plate electrode 1 is sandwiched between the holder 4A as taught in the present embodiment, the metal wire 7 is preferably furnished at the position of the center of gravity of the plate electrode 1.

Signal input terminals 6 are furnished on the second surface 5B of the substrate 5. The signal input terminals 6 are configured by a signal input terminal 6A for connection to the plate electrode 1, and a signal input terminal 6B for connection to the diaphragm 3. Consequently, the signal input terminals 6 comprise a pair. The signal input terminal 6A is electrically connected to the via 9. Consequently, the first surface 5A and the second surface 5B of the substrate 5 are electrically connected, making it possible to electrically connect the signal input terminal 6A and the plate electrode 1.

Herein, the plate electrode 1 and the diaphragm 3 which are sandwiched between the holder 4A and the diaphragm ring 4B comprising a configuration such as the aforementioned are arranged on the substrate 5 and are housed within the casing 10. In the present embodiment, the diaphragm 3 is secured by bonding to the diaphragm ring 4B, and electrically connected. The casing 10 comprises a cylindrical shape. On a first surface in the axial direction of the casing 10, a sound hole 10A is formed at a position in opposition to the diaphragm 3. On a second surface of the casing 10, there is formed an opening 10B for exposing the signal input terminals 6 furnished on the substrate 5 as mentioned previously. In the present embodiment, this casing 10 comprises a conductive material. The diaphragm ring 4B is also configured by a conductive material. Therefore, the diaphragm 3 and the signal input terminal 6B for connection to the diaphragm 3 are connected at least via the casing 10, specifically, via the diaphragm ring 4B and the casing 10. Consequently, by inputting a signal from the signal input terminals 6A, 6B furnished on the second surface 5B of the substrate 5, it is possible for the signal to be transmitted to the plate electrode 1 and the diaphragm 3.

With the sounding body 100 according to the present invention, a condenser can be configured by one plate electrode 1 and one diaphragm 3. Therefore, as compared with a conventional structure in which the condenser comprises two plate electrodes and one diaphragm, a more compact configuration is possible. Moreover, with regard to control of electrical continuity, two controls, namely, of the one plate electrode 1 and of the one diaphragm 3, suffice, thereby making it possible to perform control easily. Additionally, because the sound hole 10A is formed at a position in opposition to the diaphragm 3, it is possible for sound generated by vibration of the diaphragm 3 to be easily extracted through the sound hole 10A. Moreover, the signal input terminals 6 can be configured by two terminals connected to the plate electrode 1 and the diaphragm 3 respectively. Consequently, production cost can be reduced, making possible realization at low cost. Further, by furnishing the spacer 2 between the plate electrode 1 and the diaphragm 3, a fixed gap can be maintained between the plate electrode 1 and the diaphragm 3, making it possible to obtain stabilized sensitivity. Moreover, by virtue of a structure in which the components mentioned above are housed in the casing 10, it is possible to achieve a compact size overall.

### Second Embodiment

Next, a sounding body 100 according to a second embodiment is described. In the aforementioned first embodiment, the plate electrode 1 and the land 8 are connected by a metal wire 7. The sounding body 100 according to the present embodiment differs from the first embodiment in that connection is performed via a tubular member 20, instead of the metal wire 7. In other respects, the configuration is comparable to that of the first embodiment. Following is a discussion of portions that differ from the first embodiment.

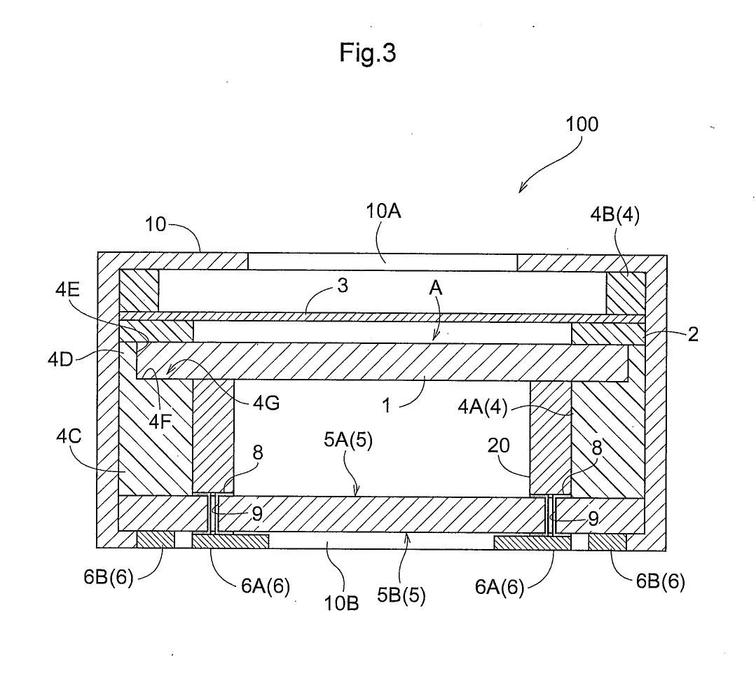

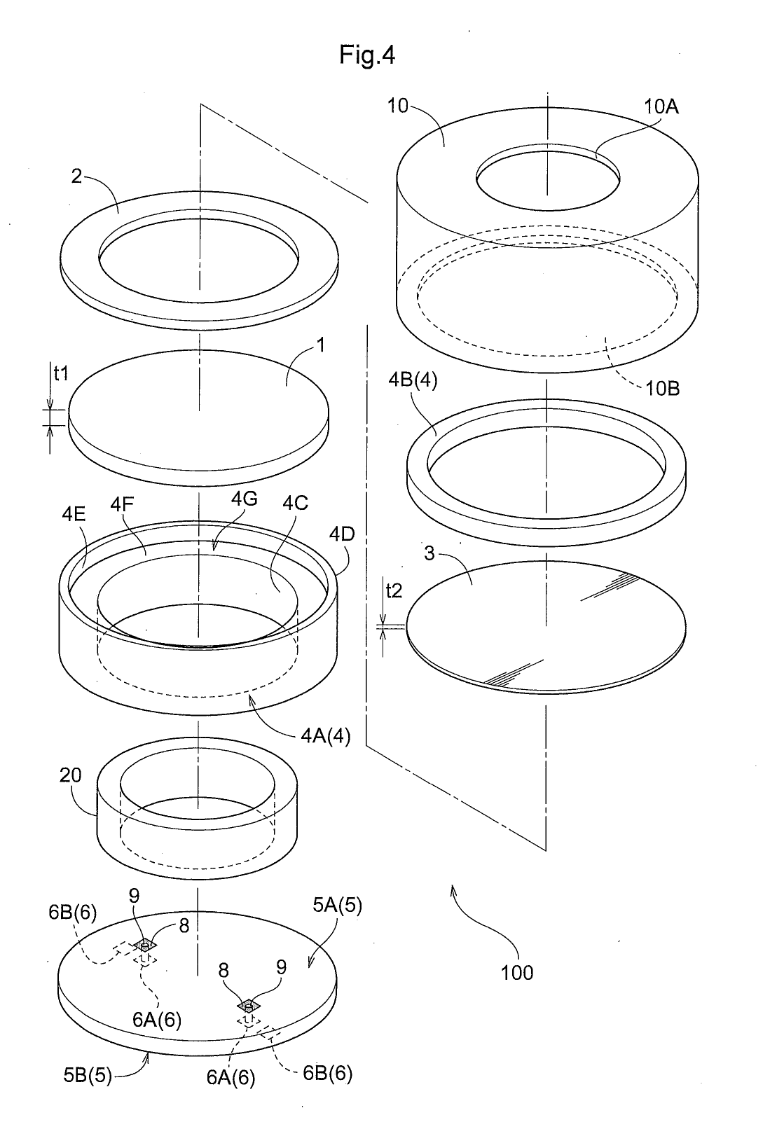

A cross sectional view of the sounding body 100 according to the present embodiment is shown in FIG. 3, and a development view of the sounding body 100 according to the present embodiment is shown in FIG. 4. The tubular member 20 comprises a conductive material of cylindrical shape. The outside diameter of the tubular member 20 is defined to a size such that the tubular member 20 is able to pass through the diametrical center section of the holder 4A. Specifically, it is formed smaller than the inside diameter of the holder 4A. Consequently, the tubular member 20 is furnished along the inside peripheral surface of the holder 4A which is one of the sandwiching sections 4. The inside diameter of the tubular member 20 is not particularly limited, it being sufficient for there to be at least some thickness in the diametrical direction. The axial length of the tubular member 20 is configured as a length equal to the axial length of the small-diameter section 4C of the holder 4A. By configuration of the tubular member 20 in this fashion, it is possible for the plate electrode 1 and the signal input terminal 6A for connection of the plate electrode 1 to be connected via the tubular member 20, the land 8, and the via 9.

### Third Embodiment

Next, an earphone 200 according to the present invention is described. The earphone 200 is provided with the sounding body 100 and a case member 50. The sounding body 100 may be the one described in the first and second embodiments, and therefore discussion is omitted here.

The case member 50 is configured to be capable of housing the sounding body 100. A sound output section 51 is formed on the case member 50, at a location in opposition to the sound hole 10A. The user faces this sound output section 51 towards the earhole and inserts the earphone 200, whereby it is possible for the user to appropriately listen to sounds generated through the sound hole 10A. A cable 52 that connects the earphone 200 to audio equipment (not shown) connects to the signal input terminals 6A, 6B respectively.

With the earphone 200 according to the present invention, it is possible to configure an earphone 200 with good characteristics that is moreover compact.

### Additional Embodiments

In the aforementioned embodiments, the sounding body 100 was described. For this sounding body 100, the voltage of the signal input to the sounding body 100 is preferably 10 V or above. That is, in a case in which the sound signal output from audio equipment is a digital signal, it is converted to an analog signal by a digital to analog converter (DAC), and the analog signal is amplified. On the other hand, in a case in which the sound signal output from audio equipment is an analog signal, the analog signal is amplified. In the sounding body 100 according to the present invention, the analog signal amplified in this way is clamped to the aforementioned 10 V or above.

In a case in which clamping is to be performed in this way, it is possible to employ a voltage conversion section. The voltage conversion section boosts the sound signal input to the sounding body 100, and is housed in the case member 50. As the voltage conversion section, for example, a transformer or regulator could be utilized. In a case in which a transformer is used, it is possible to clamp by employing a voltage boosted by the winding ratio of the winding configuring the transformer. In this case, in order to prevent impedance mismatch, it is preferable to furnish a buffer to the input stage of the transformer. The buffer may be configured by an operational amplifier, or a buffer IC may be employed. In a case in which a regulator is employed, it is possible, for example, to clamp by employing a voltage boosted by a switching regulator. Alternatively, since the current consumed by the sounding body 100 is small, clamping may employ a voltage boosted by a Cockcroft-Walton circuit.

In the second embodiment, the plate electrode 1 and the signal input terminal 6A for connection to the plate electrode 1 are described as being connected via the tubular member 20 that is furnished along the inside peripheral surface of the holder 4A. However, the scope of implementation of the present invention is not limited thereto. Rather than employing the tubular member 20, a configuration whereby the plate electrode 1 and the signal input terminal 6A are connected is also possible. Specifically, it is possible to connect the plate electrode 1 and the signal input terminal 6A by a metal wire. Even in a case in which the tubular member 20 is employed, it is possible to not furnish it along the inside peripheral surface of the holder 4A.

In the first embodiment, the diaphragm 3 and the signal input terminal 6B for connection to the diaphragm 3 are described as being connected via the diaphragm ring 4B and the casing 10. However, the scope of implementation of the present invention is not limited thereto. It is possible for the diaphragm 3 and the signal input terminal 6B to be connected, for example, by a metal wire, rather than via the diaphragm ring 4B and the casing 10.

In the embodiments, the sound output section 51 of the earphone 200 is described as being disposed in opposition to the sound hole 10A of the sounding body 100. However, the scope of implementation of the present invention is not limited thereto. It is possible for the sound output section 51 of the earphone 200 to be disposed at a location not in opposition to the sound hole 10A of the sounding body 100.

In the preceding embodiments, the spacer 2 was described as preferably being configured to have a thickness of about 0.2 mm, for example. However, the scope of implementation of the present invention is not limited thereto. It is possible to be thicker or thinner than 0.2 mm.

In the preceding embodiments, the members configuring the sounding body 100, as well as the earphone 200, are described as being cylindrical in shape. However, the scope of implementation of the present invention is not limited thereto. It is possible for these to be configured by a polygonal shape.

In the preceding embodiments, the plate electrode 1 and the diaphragm 3 are described as comprising a conductive material. A configuration in which either the plate electrode 1 or the diaphragm 3 comprises an electret material that supplies a polarization voltage is also possible. In this case, by having polarization voltage be supplied by the electret, it is possible to obviate the need for a bias voltage.

In the preceding embodiments, the inside diameter of the small-diameter section 4C of the holder 4A is described as being an inside diameter that is the same as the inside diameter of the spacer 2. However, the scope of implementation of the present invention is not limited thereto. It is possible for the inside diameter of the small-diameter section 4C of the holder 4A and the inside diameter of the spacer 2 to be configured by different diameters.

In the preceding embodiments, the axial length of the large-diameter section 4D is described as being such that, in a state in which the plate electrode 1 is mated within the recessed section 4G, the plate electrode 1 does not protrude out from the axial end section of the large-diameter section 4D. However, the scope of implementation of the present invention is not limited thereto. Specifically, it is possible for the plate electrode 1 to be configured to protrude out from the holder 4A. In this case as well, because the distance between the diaphragm 3 and the plate electrode 1 is equal to the thickness of the spacer 2, it is possible to appropriately set the distance between the diaphragm 3 and the plate electrode 1.

The present invention is utilizable in a condenser-type sounding body unit provided with a diaphragm and a plate electrode, and in an earphone employing the condenser-type sounding body unit.

What is claimed is:

1. A condenser-type sounding body unit, comprising:
a casing;
a plate electrode comprising a conductor;
a diaphragm disposed in opposition to the plate electrode;
a spacer for insulating the plate electrode and the diaphragm, the spacer disposed between the plate electrode and the diaphragm;
a pair of signal input terminals electrically connected to the plate electrode and the diaphragm respectively; and
a sandwiching section;
wherein
the sandwiching section has a first sandwiching section comprising an insulating material and a second sandwiching section comprising a conductive material;
the sandwiching section sandwiches the plate electrode and the diaphragm from both sides in the direction of opposition;
the diaphragm, in a state of being affixed to the second sandwiching section, is housed within the casing; and
a sound hole is formed in the casing in a position in opposition to the diaphragm.

2. The condenser-type sounding body unit of claim 1 wherein
the plate electrode and the signal input terminal for connection to the plate electrode are connected via wiring furnished to the plate electrode, in a central portion of an area thereof surrounded by the sandwiching section.

3. The condenser-type sounding body unit of claim 1 wherein
the plate electrode and the signal input terminal for connection to the plate electrode are connected via a tubular member furnished along the inside peripheral face of either the first sandwiching section or the second sandwiching section.

4. The condenser-type sounding body unit of claim 1 wherein
the diaphragm and the signal input terminal for connection to the diaphragm are connected at least via the casing.

5. An earphone comprising:
the condenser-type sounding body unit of claim 1; and
a case member for housing the condenser-type sounding body unit;
wherein
the case member has a sound output section disposed in opposition to the sound hole.

6. The earphone of claim 5 further comprising:
a voltage conversion section for boosting a sound signal input to the condenser-type sounding body unit, the voltage conversion section being housed in the case member.
